(19) United States
(12) Patent Application Publication
(10) Pub. No.: US 2019/0359403 A1
(43) Pub. Date: Nov. 28, 2019

(54) A PROCESS AND APPARATUS FOR MANUFACTURING BAGS MADE OF BIODEGRADABLE MATERIAL PLASTIC AND BAG THUS OBTAINED

(71) Applicant: SIPA BIOPACKAGING O.O.D., Sofia (BG)

(72) Inventor: Tommaso LOVATI, Tradate (IT)

(21) Appl. No.: 16/484,990

(22) PCT Filed: Feb. 21, 2018
(86) PCT No.: PCT/IB2018/051055

§ 371 Date: Aug. 9, 2019

(30) Foreign Application Priority Data
Mar. 3, 2017 (IT) 102017000024200

(51) Int. Cl. B65D 65/46; B31B 70/18; B31B 70/64; B31B 70/86; B65D 33/16; B65D 33/06

(52) U.S. Cl. CPC B65D 65/466; B31B 70/18; B31B 70/644; B31B 2155/003; B31B 70/874; B65D 33/1608; B65D 33/065; B31B 70/872

(57) ABSTRACT

A process for manufacturing bags made of a biodegradable or biodegradable-compostable plastic material and without any bellows, said process comprising the following sequence of steps: loading a reel (12′) of plastic film (13) obtained by blown-film extrusion and having a width which corresponds to the width of at least one bag (50) to be formed; longitudinally cutting along cutting lines (15) to form at least two longitudinal bands (13′); separating the bands to a given “D” distance from each other, and longitudinally welding; said steps being a function of the transversal dimension or width of the bag to be manufactured; transversally welding each individual longitudinal band (13′) to define band portions (27) which corresponds to the longitudinal dimensions of the bags (50) to be formed, punching said band portions (27), moving and unloading the bags (50) thus formed.

The present invention refers to a process and an apparatus for manufacturing bags made of a biodegradable material and to bags thus obtained.

More specifically, the present invention refers to a process and its respective apparatus for manufacturing bags made of a biodegradable or biodegradable-compostable material, said bags, specially but not exclusively, being suitable for using in the food sector as bags or envelopes for fruit and vegetable products or the like, or also as bags for household refuse, bags for collecting animal waste, etc.

It is known that bags constitute a special packing type that, the volume being equal, has a lower weight in comparison with that of other packing types such as, for instance, boxes, cans or the like, and they are also easier to compact in case of non-use.

Typically, the above-mentioned bags are made from a plastic material, for instance polyethylene or a similar material. However, in many countries using such type of material for manufacturing bags is not authorized any longer, because it does not meet the standards for biodegradable and compostable materials.

In order to solve such problems, bags formed of biodegradable-based components such as, for instance, starches (cornstarch and the like), polylactic acids (PLA) and the like or even compounds of materials that make it possible to realize envelopes or bags with excellent resistance and aesthetic characteristics (colored, transparent, opaque bags and the like), have been manufactured; also, such films made from a biodegradable and compostable material include a content of renewable source ranging from 0% to 100% (such percentage value can vary also as a function of each individual country standards).

Bags made of such biodegradable and compostable materials are manufactured starting from extruded films (for instance, by using a blow-film extrusion process) which are made to pass through roll stacks in such a way as to form a film which is coil wound and is subsequently used to form bags having the desired shapes and dimensions.

Traditional bags such as, for instance, those used for shopping in supermarkets or those used in fruit and vegetable sections have a configuration called “shopper” or “T-Shirt”-like and include a bag-body having a lower portion (which defines the bag bottom), an upper portion, and lateral opposed portions placed between said lower portion and upper portion, said lateral portions being folded towards the inside of the body-bag to define longitudinally extending bellows, an opening cut in correspondence with the central part of the upper portion and suitable for defining the shape of the opposed gripping handles of the above-mentioned types of bags formed as a longitudinal extension of the lateral portions.

Other types of bags made from the above-mentioned materials might be unprovided with the above-described gripping handles and, in this case, the upper portion might be provided with a plastic band to close the bag or with a through central opening, which defines a compartment in which the user can insert the fingers of his/her hand.

However, such known types of bags feature some important drawbacks mainly bound to the presence of bellows formed on the lateral portions of the bag.

As a matter of fact, as it is known, the film layers or the film itself that defines the bag are joined, in correspondence with the bottom portion of the bag, through a heat sealing.

The bottom portion, due to the presence of the opposed lateral bellows, comprises two lateral portions defined by four film layers (the bellow is obtained by folding the film) and a central portion defined by two film layers; the heat sealing of the bottom portion thus defined is performed in one step by way of one welding clamp whose operating temperature is set also to make it possible to weld the four layers of the lateral portions and the two layers of the central portion arranged between said lateral layers where the bellows are formed.

This fact entails that, during the heat-sealing step, the central portion of the bottom portion is submitted to a temperature greater than that sufficient to join the two film layers to each other (as a matter of fact, the heat-sealing temperature has to allow to join the four layers defining the bellows) and this determines the formation of points or areas of discontinuity in the area of joining of the bellows (four layers or sheets) and in the central portion of the bottom portion (two layers or sheets), said discontinuity points determining a weakness of the bottom portion in correspondence with the points where the bellows terminate, and said portion, being weaker in the mentioned points, might open or tear as a consequence of the weight of the products inserted therein.

A further drawback of such known type of bags is bound to the fact that the presence of the lateral opposed bellows lessens the carrying capacity of the bag itself.

A further drawback is the fact that such traditional bags, given the presence of the lateral bellows, don't allow to optimally distribute the products that are inside the bag and this might affect the resistance of the bag.

This fact entails a correlated drawback bound to the fact that these bags provided with bellow cannot be reused as bags for decomposable collection and that by virtue of the fact that, as stated above, they tend to break in correspondence with the discontinuity areas located in the area where the bellows and the central portion of the bottom portion are joined to each other.

An object of the present invention is to eliminate the above-mentioned drawbacks.

More specifically, an object of the present invention is to provide a process for manufacturing a bag made of a biodegradable or biodegradable-compostable material, having a content of renewable source ranging from 0% to 100%, without bellows and with one bottom welding suitable for providing a high resistance as well as load distribution/mechanical stresses bound to the presence of products inside said bag.

A further object of the present invention is to provide a process suitable for manufacturing a bag suitable for providing an optimum and uniform distribution of the product to be inserted therein.

A further object of the present invention is to provide a process suitable for manufacturing a colored, opaque, or transparent bag.

A further object of the present invention is to provide a process for manufacturing bags suitable for being implemented on apparatuses of a traditional type.

A further object of the present invention is to make available to users a process and the apparatus for manufacturing bags made of a biodegradable material suitable for providing a high resistance and reliability over time as well as capable of being manufactured in an easy and cost-effective manner.

These objects and others are achieved by the invention featuring the characteristics described in claim 1.

According to the invention, a process and an apparatus for manufacturing bags made of a biodegradable or biodegradable-compostable material and free of bellows is provided, said process comprising a sequence of steps, in particular: loading a reel of a biodegradable or biodegradable-compostable plastic obtained by blown-film extrusion and having a width which corresponds to the width of at least one bag to be formed; unwinding and tensioning said plastic film; longitudinally cutting the plastic film along given cut lines and forming at least two longitudinal bands; separating said at least two longitudinal bands to a “D” distance from each other; longitudinally welding each of the at least two longitudinal bands along at least one of the opposed longitudinal edges of each longitudinal band; said steps of longitudinally cutting, separating and longitudinally welding being performed as a function of the transversal dimension of the plastic film and of the transversal dimension or width of the bag to be manufactured; transversally welding each longitudinal band with a pace or speed which is a function of the longitudinal development dimension of each individual bag to be manufactured to define band portions corresponding to the dimensions of the bags to be formed; punching said band portions; moving and unloading of the bags thus formed.

Advantageous embodiments are apparent from the dependent claims.

The constructional and operational characteristics of the process and the apparatus for manufacturing bags made of a biodegradable or biodegradable-compostable material and the bags thus obtained according to the present invention, can be better understood from the detailed description which follows, wherein reference is made to the attached drawings which illustrate a preferred, and non-limitative, embodiment, and wherein:

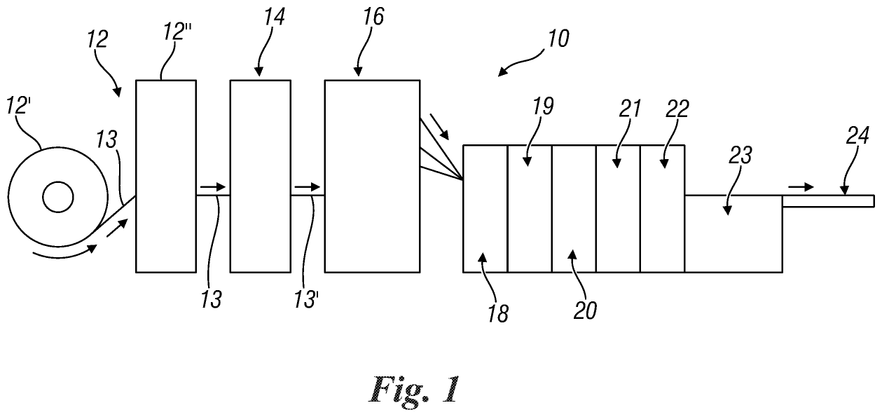

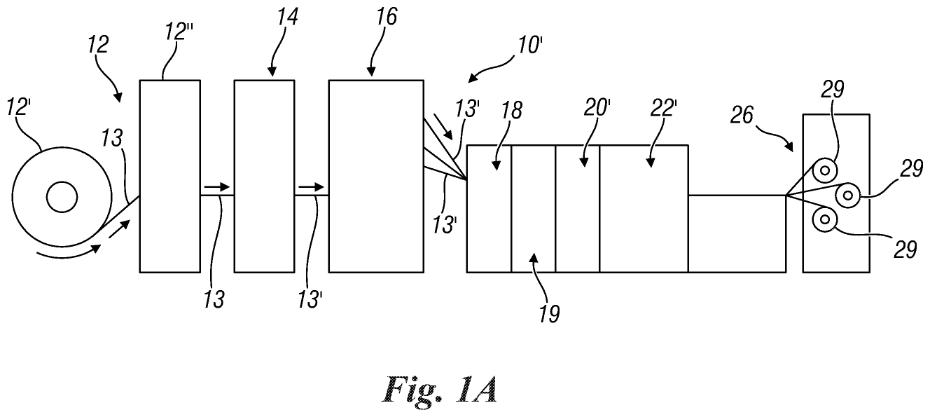

FIG. 1 shows, at schematic level, a front view of an apparatus for manufacturing bags made of a biodegradable material by way of the process according to the invention;

FIG. 1A shows, at schematic level, a front view of an apparatus for manufacturing bags in accordance with an alternative embodiment;

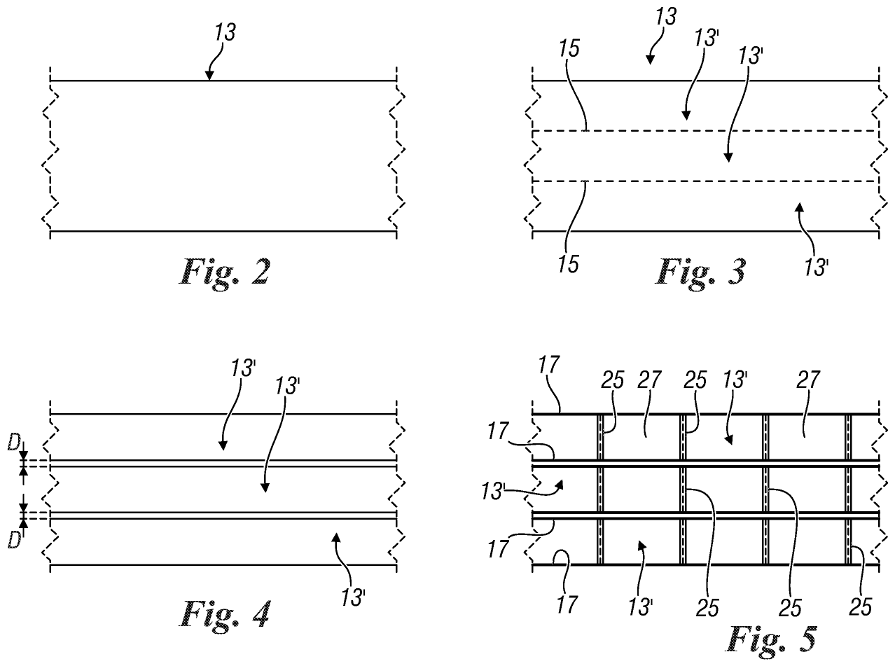

FIGS. 2 thru 9 schematically show the sequence of steps of the process according to the invention applied to a relevant apparatus for manufacturing bags made of a biodegradable material;

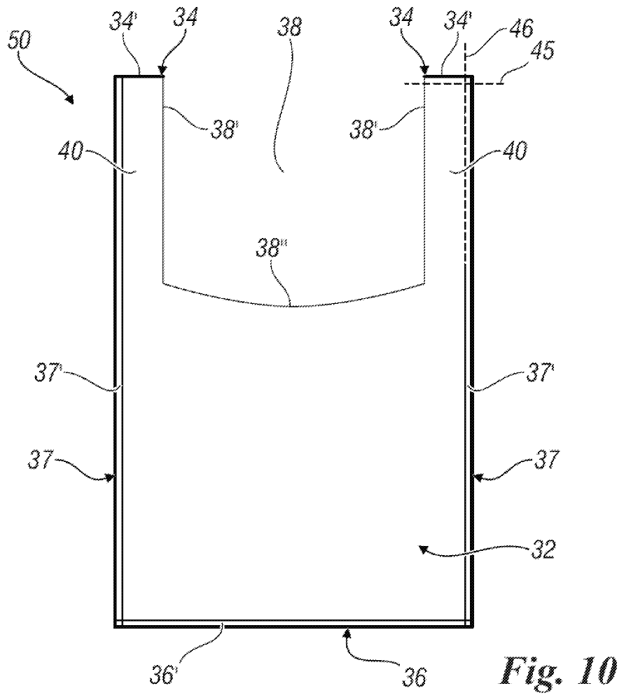

FIG. 10 schematically shows a type of bag manufactured in accordance with the process according to the invention.

With reference to the mentioned figures, the process for manufacturing bags made of a biodegradable material according to the invention is here below described with reference to the operating steps performed on an apparatus according to FIGS. 1 and 1A, said apparatus being identified, as a whole, by the references 10 and 10′ respectively.

With reference to FIG. 1, the apparatus 10 comprises a reel loading-unwinding station 12, a first cutting station 14, a separating station 16, if any, a longitudinal welding station 18, a transversal welding station 19, a transversal cutting station 20, an accumulating station 21, a punching station 22, a collecting and folding station 23, and an unloading station 24.

The reel loading-unwinding station 12 comprises a first substation, wherein a biodegradable or biodegradable-composable plastic film reel 12′ is loaded and a second substation 12″, wherein the plastic film 13 of the reel 12′ is made to move forward, and is tensioned in order to move to the processing stations described below.

The plastic film 13 of the reel 12′ is formed of a film comprising a blend of biodegradable materials obtained, for instance, from starches and from a polylactic acid (however, the composition of the material forming the plastic film is known and it will not be described here).

Said plastic film can also be colored or opaque or even transparent and can have words or logos imprinted or similar graphical signs repeated throughout the longitudinal development of the film wound on the reel 12′; in an alternative embodiment the plastic film 13 might be unprovided with words, logos or similar signs imprinted thereon.

With reference to the preferred embodiment shown in the figures (schematically depicted in FIG. 2 as a portion of the plastic film) the plastic film 13 which outputs the reel loading-unwinding station 12 is made to move along the first cutting station 14, where said plastic film 13 is submitted to a longitudinally cutting step, performed along cutting lines 15, which subdivides the plastic film 13 into at least two continuous longitudinal bands 13′ (in the embodiment illustrated in the figures and, specifically in FIG. 3, the longitudinal bands are three).

The at least two longitudinal bands 13′, which output from the first cutting station 14, move along the separating station 16, if any, where said at least two bands 13′ are separated and spaced away from each other, as schematically shown in FIG. 4; said separation and spacing away operation of each individual band is performed by means of a plurality of rollers (not illustrated in the figures because they are already known in the art) which move and stagger the mentioned at least two longitudinal bands so that in the output of said separating station 16, the longitudinal bands 13′ preferably lay on one and the same plane and are spaced away from each other of a “D” distance (as illustrated in FIG. 4).

The at least two bands 13′ outputting from the separating station 16 and spaced away as schematically shown in FIG. 4, are made to move along the longitudinal welding station 18 where each of said at least two bands 13′ are welded along the longitudinal edges 17, as illustrated in FIG. 5.

The longitudinal bands 13′ thus welded along the longitudinal edges 17 subsequently move towards a transversal welding station 19 where on each band transversal welding strips 25 are made parallel to each other to define band portions 27, which ultimately will form each individual bag; accordingly, the transversal welding strips 25 are made with a pace or speed as a function of the longitudinal development dimension of each individual bag (FIG. 5).

In particular, said transversal welding strips 25 are suitable for defining upper and bottom portions of a single bag and, consequently, typically have a thickness greater than that which feature the weldings along the longitudinal edges 17 and, preferably, they are “duals”; the latter because, in accordance with a type-bag preferred embodiment, described below, in correspondence with the central portion of the single welding strip, a transversal cut suitable for separating the single band portions 27 from each other will be performed.

The transversal cutting step, suitable for obtaining from each longitudinal band 13′, as already described, single band portions 27, is performed in the transversal cutting station 20.

According to an alternative embodiment, both the transversal welding step and transversal cutting step can be performed in one and the same transversal welding and transversal cutting station, in which the above described transversal welding and the above described transversal cutting are performed simultaneously (for instance, by means of a welding head provided with a cutting blade).

According to a further alternative embodiment, on each longitudinal band 13′ a transversal cut is not performed, as described above, but rather a pre-cut or knurling which maintains the individual band portions 27 joined to each other.

The band portions 27 which output the transversal cutting station 20 are moved towards a next accumulating station 21 in which said band portions 27 are superimposed to each other to define a ream 28 of single band portions 27.

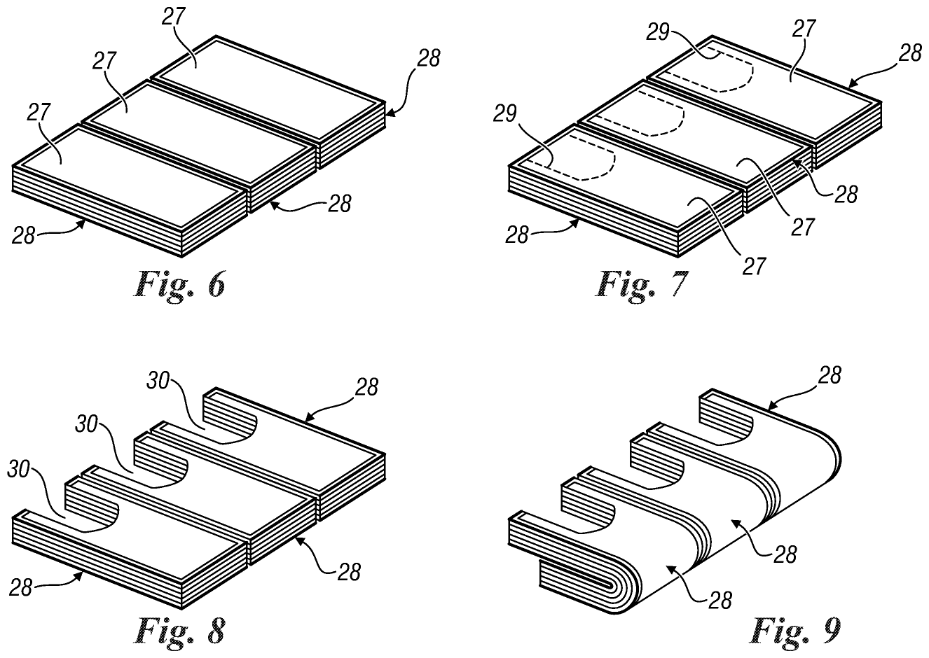

FIG. 6 shows three reams 28 of band portions 27 obtained from three longitudinal bands 13′.

The reams 28 of band portions 27 are subsequently moved in correspondence with a punching station 22 where a punch (not shown in the figures) cuts the ream of band portions (according to a cut direction perpendicular to the direction of the longitudinal development direction of the band portions) in order to define an opening 30 in correspondence with the upper portion of the band portion 27.

The band portions 27 thus stacked to define the reams 28 and punched as described above, go into a collecting and folding station 23 in which the reams or bundles are folded like a book (i.e. a double fold along folding lines transversal to the longitudinal development of the bag) as schematically shown in FIG. 9.

According to an alternative embodiment, the collecting and folding station can perform a folding like a booklet (i.e. a three folds).

The reams or bundles 28 thus folded, according to the embodiment of the apparatus shown in FIG. 1, are moved by means of a conveyor belt towards an unloading station 24, where said bundles are accommodated, for instance, inside boxes or container elements.

It goes without saying that the foregoing description refers to a preferred, but non-limitative solution, according to which the plastic film 13 of the reel 12′ features a width or transversal dimension which corresponds to the width or transversal dimension of two or more bags placed side by side.

However, depending on the logics of production, the process for manufacturing bags according to the invention can be performed starting from a plastic film whose transversal development dimension corresponds to the transversal development dimension of one bag that is intended to be manufactured and in this case, considering that the mentioned plastic film 13 is obtained by a process of a “blown-film” extrusion type, it is not necessary to perform either the longitudinal cut of said plastic film or the longitudinal welding step and, in addition, it is not necessary to perform the step whereby the longitudinal bands 13′ obtained from the plastic film 3 are spaced away from each other; in this case, the longitudinal cutting station, longitudinal welding station as well as the separating step are not necessary, whereas the following steps shall be performed, i.e. the steps of transversal welding, transversal cutting or pre-cutting, punching, and reel folding or winding.

In addition, in the case that the plastic film 13 is divided into two longitudinal bands 13′, the longitudinal welding of each individual band is necessary only in correspondence with the longitudinal cut edge and this in dependence on whether the plastic film 13 comes from a “blown-film” production process or not.

FIG. 1A schematically shows the apparatus for manufacturing bags made of a biodegradable material according to an alternative embodiment 10′ and, in particular, an apparatus in which the formed bags are wound up in reels as better explained below.

The apparatus 10′ comprises workstations similar to those previously described with reference to the apparatus 10 illustrated in FIG. 1 and to the alternative embodiments depending on the dimensional characteristics of the plastic film in the reel, such workstations will be identified by the same numeral reference as in FIG. 1.

As already described, a reel 12′ of plastic film 13 made of a biodegradable or biodegradable-compostable material (having a content of renewable source ranging from 0% to 100%) is loaded on a first substation of the loading/unwinding reel station 12 and by way of a second station 12″ (not described because already known in the art) said plastic film 13 is tensioned and moved towards the first cutting station 14, if any, (it is not used if a reel whose transversal dimension corresponds to the transversal dimension of the single bag is used) where said plastic film 13 is subjected to a longitudinal cutting step, performed along cutting lines 15, said cut dividing the plastic film 13 into at least two continuous longitudinal bands 13′ whose transversal dimension corresponds to the transversal dimension of the bag intended to be manufactured.

Therefore, the at least two longitudinal bands 13′ are moved in the direction of the separating station 16, where they are separated and spaced away from each other, as previously described with reference to FIG. 4.

The at least two longitudinal bands 13′ at the output from the separating station 16 are made to pass internally the longitudinal welding station 18, where each longitudinal band is welded along its opposed longitudinal edges 17.

Then, the longitudinal bands 13′ thus welded move into the transversal welding station 19, where on each band transversal welding strips 25 parallel to each other are made to define band portions 27, which will form single bags; accordingly, the strips of transversal welding 25 are made with a pace or speed which is functional to the longitudinal development dimension of the single bags.

Said strips of transversal welding 25 are suitable for defining upper and bottom portions of a single bag and, consequently, their thickness is typically greater than that of the weldings along the longitudinal edges 17 and, preferably, they are “duals”, and this because, according to the apparatus 10′, in correspondence with the central portion of the single strip of welding a transversal pre-cut suitable for spacing the single band portions 27 away from each other will be performed.

This pre-cut is performed after the transversal welding step in the pre-cutting station 20′.

However, according to an alternative embodiment of the apparatus 10′, this pre-cutting step can be performed in the transversal welding station 19 simultaneously to the welding operation.

The single longitudinal bands 13′ thus welded along the longitudinal edges, provided with transversal welding and with pre-cut, proceed to a punching station 22′ in which the punching operation is performed in order to obtain a bag shape of a “shopper” type, like a “t-shirt”, or in which the opening for holding the bag is simply performed. Thereafter, the longitudinal bands 13′ thus shaped are moved towards a winding station 26, in which they are wound in reels 29.

FIG. 10 schematically shows a bag 30 made of a biodegradable or biodegradable-compostable material manufactured by means of the above described apparatus and process.

The bag 30 comprises a body 32 defined by an upper portion 34, a bottom portion 36, which is opposed and parallel to the upper portion, and two longitudinally developed, opposed lateral portions 37, which are situated between said upper portion 34 and bottom portion 36, an opening 38 made on the upper part of the body 32 so as to obtain a configuration of a “shopper” or “t-shirt” type having two opposed handles 40.

The upper portion 3 has a welded edge 34′, the bottom portion 36 has a welded edge 36′, and the opposed lateral portions 37 can include at least one welded edge 37′ throughout the longitudinal development of the lateral portions themselves.

The presence of at least one welded edge 37′ depends on the type of plastic film of the reel loaded on the forming apparatus; as a matter of fact, assuming that, as previously described, the plastic film features a width or a transversal dimension which corresponds to the width or transversal dimension of the bag, considering that the plastic film is of a “blow-film” manufacturing type, the opposed lateral portions 37 do not have the welded edges 37′, and should the plastic film be submitted to only one longitudinal cut which originates two longitudinal bands 13′, each bag comprises just one lateral portion provided with a welded edge 37′ (i.e. the portion in correspondence with the longitudinal cut).

The opening 38, obtained by way of a punching operation, is of a “C” type and includes two opposed open sides 38′ in correspondence with the handles 40 on the opposed part with respect to the lateral portions 37 provided with welded edges 37′ and a further open side 38″ arranged transversally with respect to the opposed open sides 38′. The handles 40 thus defined allow the user to hold the bag during the loading step (the user will hold the bag with the fingers of one hand and with the other hand he/she will fill the bag), closing it by knotting the mentioned handles to each other.

According to an alternative embodiment, one or both the handles 40 can be cut by shearing them along a transversal shearing line 45 in proximity of the welding 34′ made in the upper portion 34.

According to a further embodiment, one or both handles can be cut by shearing them even along one longitudinal shearing line 46 of the lateral portion 37 in addition to the above described cut along the transversal shearing 45 of the upper portion 34, said longitudinal shearing line 46 being developed for an extension which corresponds to the extension in length of the handle; in this way, the two handles 40 will define four separated borders to be knot to each other to close the bag.

Also, according to a further embodiment one or both handles can be cut by shearing along a longitudinal shearing line of the lateral portion 37, said longitudinal shearing line 46 being developed along a length which substantially corresponds to the development in length of the handle; in this way, one or both handles 40 will define a through opening which makes it possible for the user to introduce the fingers of his/her hands.

As can be inferred from the foregoing, the advantages that the process and apparatus of the invention achieve are evident.

The apparatus according to the invention, by way of the above described process, makes it possible to manufacture a bag made of a biodegradable or biodegradable-compostable plastic material without any bellows (having a percentage of renewable source ranging from 0% to 100%), the bottom being provided with one welding suitable for providing a high resistance and load distribution as well as mechanical stresses bound to the presence of the products inserted into the bag.

A further advantage of the present invention consists in that the bag obtained by way of the process and the apparatus of the invention provides an optimum and uniform distribution of the products insertable into the bag itself.

A further advantage is the fact that the absence of the bellows, typically formed along the lateral portions, makes it possible to obtain a saving in terms of production time and, consequently, a cost reduction in that, in certain cases, the absence of the bellow entails not having to interpose the strips made of Teflon in the bellows themselves in order to perform the welding.

The above highlighted advantages determine a further advantage bound to the envelope or bag obtained according to the process and apparatus of the invention, said advantage consists in that the described envelope or bag, its dimensions being equal to a traditional bag having a bellow, have a capacity, measured in cubic centimeters (cm³) or liters, which is clearly greater than that of a traditional bag with bellow.

A further advantage is the fact that the above described process makes it possible to use less material as compared to known processes and, consequently, it is more cost-effective as well as environmentally friendly from a viewpoint of environmental impact.

A further advantage consists in that the process of the invention makes it possible to manufacture biodegradable or biodegradable-compostable bags without any bellows organized in reams or bundles folded or wound in reels without any needs of making complex modifications in the existing production plant.

A further advantage is the fact that the process and the apparatus of the invention are capable of obtaining bags organized in reams or bundles of single bags separated from each other or in reams and bundles of bags joined to each other and detachable upon use by way of the precut or transversal knurling made in correspondence with the transversal welding portion.

A further advantage is the fact that the process of the invention advantageously makes it possible to manufacture bags suitable for collecting and containing products (such as, for instance, fruit and vegetable products) whose handles can define not the usual handle of the shopper bags in that they do not allow to grip it for introducing the fingers of a hand into the through opening of the handle and, consequently, they make it possible to obtain a saving thanks to the fact that they will be used only to contain products and not pulled out by users, as it often happens, in a considerable number of times without filling them with products such as, for instance, fruit and vegetable products; this circumstance determines a saving, for instance, for superstores or shops, which can program their stock in a more precise manner.

Even though the invention has been described above with special reference to one embodiment thereof, which has been given only for explanatory, non-limitative purposes, numerous modifications and variants will be apparent to those skilled in the art in the light of the previous description. Therefore, the present invention is to be construed to embrace all modifications and variants that fall in the scope of the following claims.

1. A process for manufacturing bags made of a biodegradable or biodegradable-compostable plastic material and without any fellows, said process being characterized in that it comprises the following sequence of steps:
loading a reel (12′) of a biodegradable or biodegradable-compostable plastic film (13) obtained by blow-film extrusion having a width which corresponds to the width of at least one bag (50) to be formed,
unwinding and tensioning said plastic film (13);
longitudinally cutting the plastic film (13) along given cutting lines (15) and forming at least two continuous longitudinal bands (13′);
separating said at least two longitudinal bands (13′) to a “D” distance from each other;
longitudinally welding each of the at least two longitudinal bands (13′) along at least one of the opposed longitudinal edges (17) of each longitudinal band (13′);
said steps of longitudinally cutting, separating and longitudinally welding being performed as a function of the transversal dimension of the plastic film (13) and of the transversal dimension or width of the bag to be manufactured;
transversally welding each longitudinal band (13′) with a pace or speed which is a function of the longitudinal development dimension of each individual bag to be manufactured to define band portions (27) corresponding to the dimensions of the bags (50) to be formed; transversally welding step which defines transversal welding strips (25) parallel to each other and defining upper portions and bottom portions of each individual bag, said transversal welding having a thickness greater than that which feature the weldings along the longitudinal edges (17);
punching said band portions (27) in order to define an opening in correspondence with the upper portion of the band portion (27);
moving and unloading the bags (50) thus formed.

2. The process according to claim 1, characterized in that the transversal welding strips (25) are formed during the transversally welding step by way of a thickness greater than the thickness made during the longitudinally welding step along at least one of the opposed longitudinal edges (17) of each individual longitudinal band (13′).

3. The process according to claim 1, characterized in that it comprises a step of cutting band portions (27) in correspondence with a central line of the strips of transversal welding (25).

4. The process according to claim 1, characterized in that it comprises a step of precutting band portions (27) in correspondence with a central line of the strips of transversal welding (25).

5. The process according to claim 1, characterized in that it possibly comprises a step of accumulating the band portions (27) in reams or bundles (28), said step being performed before or after the punching step.

6. The process according to claim 1, characterized in that the moving and unloading step comprises a step for folding the reams or bundles (28) with a configuration like a book with at least one fold.

7. The process according to claim 1, characterized in that the moving and unloading step comprises a step of winding each individual longitudinal band (13′) of precut band portions (27) in reels (28).

8. An apparatus (10, 10′) for forming bags made of a biodegradable or biodegradable-compostable plastic material and without any bellows in accordance with the process according to claim 1, characterized in that it comprises a reel loading-unwinding station (12) for loading-unwinding the reel of plastic film (13), a longitudinal cutting station (14), if any, for longitudinally cutting said plastic film in at least two longitudinal bands (13′), a separating station (16), if any, for separating said longitudinal bands (13′) from each other to a “D” distance, a longitudinal welding station (18), if any, for longitudinally welding along at least one of the outer edges of said at least two longitudinal bands (13′), a transversal welding station (19) for transversally welding each individual longitudinal band (13′), a transversal cutting or precutting station (20, 20′), a punching station (22) arranged before or after the transversal cutting or precutting station, an accumulating and unloading station (24, 26) for accumulating and unloading the bags (50) collected in reams or bundles (28) or wound in reels (29).

9. The apparatus (10, 10′) according to claim 8, characterized in that the transversal cutting or precutting station is integrated in the transversal welding station (19).

10. A bag (50) obtainable by way of the apparatus (10, 10′) according to claim 9, comprising a body (32) formed by the band portion (27) and defined by an upper portion (34), a bottom portion (36) opposed and parallel to the upper portion, said upper (34) and bottom (36) portions formed through a cut of the transversal pre-cut of the transversal welding (25) into the punching station (22′), and two longitudinally developed opposed lateral portions (37) formed by the opposed longitudinal edges (17) of said band portion (27), arranged between said upper portion (34) and said bottom portion (36), an opening (38) defined by the opening (30) in correspondence with the upper portion of the band portion (27) and which is made by punching the upper part of the body (32) in order to define two opposed handles (40), said upper portion (34) featuring a welded edge (34′), said bottom portion (36) featuring a welded edge (36′), said welded edges (34′, 36′) being formed in the transversal welding station (19) and the opposed lateral portions (37) comprising at least one welded edge (37′), if any, formed throughout the longitudinal development of the lateral portions themselves in the longitudinal welding station (18), if any, the opening (38) comprising two opposed open sides (38′) in correspondence with the handles (40) on opposed part with respect to the lateral portions (37) and one further open side (38″) arranged transversally with respect to the opposed open sides (38′), said open sides (38′, 38″) being formed in the punching station (22).

11. The bag (50) according to claim 10, characterized in that at least one of the handles (40) is cut by a shearing operation along a transversal shearing line (45) in proximity to the upper portion (34) where is made the welding 34′ and/or at least one of the handles (40) is cut by a shearing operation also along a longitudinal shearing line (46) of the lateral portion (37), said shearing along the longitudinal shearing line (46) being made individually or in combination with the cut along the transversal shearing line (45) of the upper portion (34) to define at least one handle provided with a through opening or at least one handle defined by four borders spaced away from each other and to be knot to each other in order to close the bag.
